(19) United States
(12) Patent Application Publication
(10) Pub. No.: US 2011/0234642 A1
(43) Pub. Date: Sep. 29, 2011

(54) METHOD FOR INCREASING BACKLIGHT BRIGHTNESS RESOLUTION AND METHOD FOR MODULATING BACKLIGHT BRIGHTNESS

(75) Inventor: Ching-Hung Wang, Hsin-Chu (TW)

(73) Assignee: AU OPTRONICS CORP., Hsinchu (TW)

(21) Appl. No.: 12/855,197

(22) Filed: Aug. 12, 2010

(30) Foreign Application Priority Data
Mar. 25, 2010 (TW) 099108979

(51) Int. Cl. G09G 5/10

(52) U.S. Cl. 345/690

(57) ABSTRACT

An exemplary method for increasing backlight brightness resolution is adapted for a non-emissive display device which uses a multi-bit brightness modulation data to modulate a backlight brightness thereof. The method includes the steps of: increasing a provision amount of the multi-bit brightness modulation data in a single frame period of the non-emissive display device; and multiplying a frequency of a brightness modulation signal generated according to the multi-bit brightness modulation data, wherein a multiple of the frequency multiplying is associated with the provision amount of the multi-bit brightness modulation data in the single frame period. The present invention also provides a method for modulating backlight brightness, adapted for a non-emissive display device.

### BACKGROUND

1. Technical Field

The present invention generally relates to backlight technology fields and, particularly to a method for increasing backlight brightness resolution and a method for modulating backlight brightness.

2. Description of the Related Art

In the prior art, non-emissive display devices such as liquid crystal display devices whose display panels are non-emissive, and thus backlight modules are necessarily needed for providing the display panels with backlight illumination. Nowadays, light sources used by the backlight modules can be primarily classified as cold cathode fluorescent lamp, hot cathode fluorescent lamp, light emitting diode and other electroluminescence component.

Since the liquid crystal display device generally has an observable leakage effect of light at dark states (i.e., low gray levels), along with the demand of continuously increasing the size of liquid crystal display panel and the applications of liquid crystal display panel in television systems, requirements of viewing angle of the display devices are increased compared with the traditional applications in computer systems and requirements of the leakage of light at dark states become more strict, therefore it is necessary to dynamically modulate the backlight brightness. Moreover, the dynamic modulation of backlight brightness can increase a dynamic contrast ratio for facilitating the improvement of display quality.

When a notebook computer and a liquid crystal television are taken as examples, a backlight brightness specification of the liquid crystal television (e.g., 500 nits) generally is higher than a backlight brightness specification of the notebook computer (e.g., 250 nits). Since they have different brightness specifications, in order to achieve a same backlight brightness resolution, a resolution of brightness modulation signal of the liquid crystal television (e.g., 9 bits) conventionally is set to be higher than another resolution of brightness modulation signal of the notebook computer (e.g., 8 bits), resolutions of brightness modulation signal of backlight driving circuits for carrying out backlight brightness modulations would be different from each other correspondingly. In other words, in the prior art, according to different backlight brightness specifications of display products, backlight driving circuits having different resolutions of brightness modulation signal are needed to be designed.

### BRIEF SUMMARY

Accordingly, the present invention is directed to a method for increasing backlight brightness resolution, can achieve a high backlight brightness resolution on the ground of a low-resolution brightness modulation signal.

The present invention further is directed to a method for modulating backlight brightness, can achieve a high backlight brightness resolution on the ground of a low-resolution brightness modulation signal.

More specifically, a method for increasing backlight brightness resolution in accordance with an embodiment of the present invention is adapted for a non-emissive display device. The non-emissive display device uses a multi-bit brightness modulation data to modulate a backlight brightness thereof. The method for increasing backlight brightness resolution includes the following steps of: increasing a provision amount of the multi-bit brightness modulation data in a single frame period of the non-emissive display device; and multiplying a frequency of a brightness modulation signal generated according to the multi-bit brightness modulation data. A multiple of the frequency multiplying is associated with the provision amount of the multi-bit brightness modulation data in the single frame period.

In one embodiment, the multiple of the frequency multiplying is equal to the provision amount of the multi-bit brightness modulation data in the single frame period.

A method for modulating backlight brightness in accordance with another embodiment of the present invention is adapted for a non-emissive display device. The non-emissive display device uses a multi-bit brightness modulation data to modulate a backlight brightness thereof. The method for modulating backlight brightness includes the following steps of: sequentially providing M number of the multi-bit brightness modulation data in a single frame period of the non-emissive display device, wherein M is a positive integer and larger than 1; and using the M number of multi-bit brightness modulation data to modulate the backlight brightness of the non-emissive display device in the single frame period.

In one embodiment, the step of using the M number of multi-bit brightness modulation data to modulate the backlight brightness of the non-emissive display device in the single frame period includes the following sub-steps of: demarcating the single frame period into M number of continuous frame sub-periods; and using the M number of multi-bit brightness modulation data as brightness modulation data of the respective M number of continuous frame sub-periods.

A method for modulating backlight brightness in accordance with still another embodiment of the present invention is adapted for a non-emissive display device. The non-emissive display device uses a multi-bit brightness modulation data to modulate a backlight brightness thereof. The method for modulating backlight brightness includes the following steps of: demarcating a single frame period of the non-emissive display device into a plurality of frame sub-periods; and providing each of the frame sub-periods of the single frame period with one the multi-bit brightness modulation data to generate a brightness modulation signal, and thereby the backlight brightness of the non-emissive display device in the single frame period is modulated.

In summary, the embodiments of the present invention change the provision amount of the brightness modulation data in a single frame period and perform a frequency multiplication operation applied to a brightness modulation signal generated according to the brightness modulation data, and therefore can achieve a high backlight brightness resolution through software programming at the prerequisite of no hardware change required by using the brightness modulation data with less bits (generally corresponding to low resolution of brightness modulation signal). Accordingly, the present invention can reduce the cost of display products in some degree and thus increase the competitive strength of the display products.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates an operation principle diagram of a method for modulating backlight brightness in accordance with an embodiment of the present invention.

FIG. 2 illustrates waveform diagrams of brightness modulation signals in a single frame period generated according to different brightness modulation data in accordance with an embodiment of the present invention.

### DETAILED DESCRIPTION

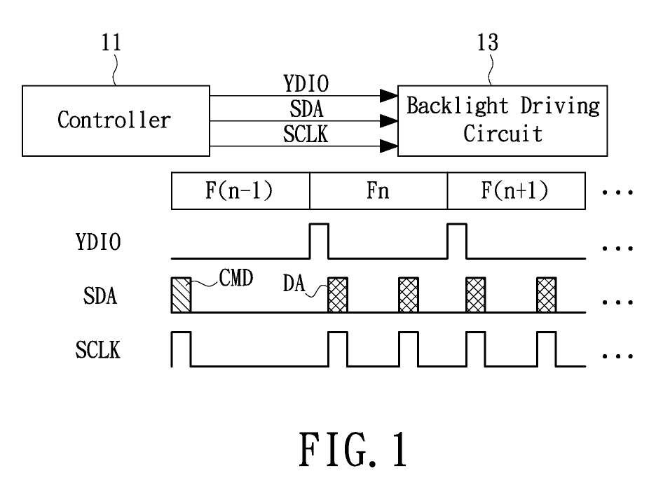

Referring to FIG. 1, an operation principle diagram of a method for modulating backlight brightness in accordance with an embodiment of the present invention is illustrated. In the illustrated embodiment, the method for modulating backlight brightness is adapted for a non-emissive display device such as a liquid crystal display device. The non-emissive display device generally uses a multi-bit brightness modulation data to modulate a backlight brightness thereof. The illustrated non-emissive display device includes a controller 1, a backlight driving circuit 13 and a backlight source (not shown in FIG. 1). The backlight source is for example a light-emitting diode (LED) array, but not limited to the present invention.

As illustrated in FIG. 1, during modulating the backlight brightness, the controller 11 provides a vertical synchronous signal YDIO, a control and data signal SDA and a synchronous pulse signal SCLK to the backlight driving circuit 13. The vertical synchronous signal YDIO serves as a start pulse signal of each single frame period. The synchronous pulse signal SCLK is used for enabling the backlight driving circuit 13 to receive the control and data signal SDA.

In the illustrated embodiment, FIG. 1 illustrates three continuous frame periods F(n−1), Fn and F(n+1) for the purpose of illustration. Firstly, in the frame period F(n−1), the controller 11 provides a control command CMD to the backlight driving circuit 13 through the control and data signal SDA, so as to inform the backlight driving circuit 13, starting from the next frame period, to generate a plurality of sequential brightness modulation signals in each single frame period, so that the backlight brightnesses of the non-emissive display device in the respective frame periods are modulated. Subsequently, in the following frame periods Fn and F(n+1), the controller 11 will provide a plurality of brightness modulation data DA to the backlight driving circuit 13 through the control and data signal SDA to allow the backlight driving circuit 13 generate a plurality of sequential brightness modulation signals according to a plurality of the brightness modulation data DA during each of the frame periods Fn and F(n+1). It is indicated that, FIG. 1 only illustrates two brightness modulation data in each single frame period for the purpose of illustration, but is not to limit the present invention, the user can suitably increase the provision amount of the brightness modulation data in each single frame period according to actual application requirement

Moreover, since the backlight driving circuit 13 generates a plurality of sequential brightness modulation signals according to a plurality of brightness modulation data DA in each single frame period, compared with the prior art that only one brightness modulation data is provided in each single frame period, the provision amount and the provision speed of the brightness modulation data DA in each single frame period are increased, a frequency of the brightness modulation signal is correspondingly multiplied. Herein, the multiple of frequency multiplication is associated with the provision amount of the brightness modulation data DA in each single frame period, for example equal to the provision amount of the brightness modulation data DA in each single frame period.

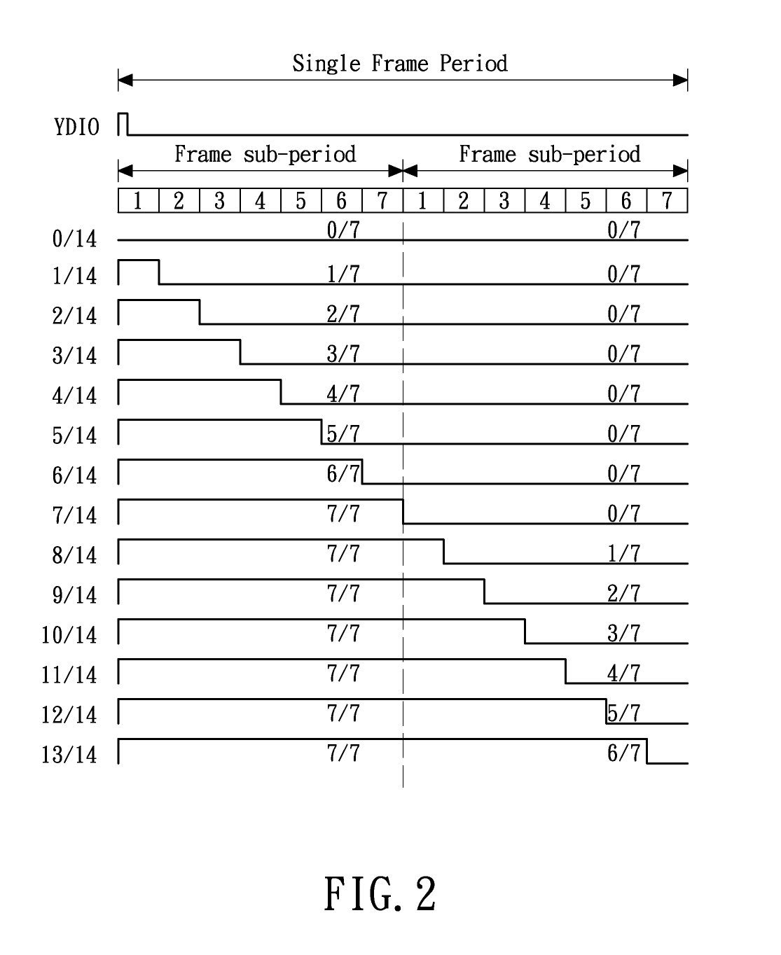

Referring to FIG. 2, illustrating waveform diagrams of brightness modulation signals in each single frame period according to respective different brightness modulation data. Hereinafter, two brightness modulation data DA being provided in each single frame period and each brightness modulation data DA being a 3-bit brightness modulation data are taken as an example to illustrate how to achieve 1 nit backlight brightness resolution for a non-emissive display device with a backlight brightness specification of 14 nits, with reference to drawings of FIGS. 1 and 2. A resolution of brightness modulation signal of the backlight driving circuit 13 is 3-bit.

As illustrated in FIG. 2, a single frame period is demarcated into two continuous frame sub-periods. In the single frame period, the backlight driving circuit 13 generates two sequential brightness modulation signals for example two sequential pulse width modulation (PWM) signals as illustrated in FIG. 2, according to two 3-bit brightness modulation data DA. In each frame sub-period, the backlight driving circuit 13 generates one the brightness modulation signal according to one 3-bit brightness modulation data DA. Herein, the control and data signal SDA as illustrated in FIG. 1 provides one the brightness modulation data DA in each frame sub-period, the backlight driving circuit 13 then generates one the brightness modulation signal in the frame sub-period according to the brightness modulation data DA. In an alternative embodiment, two brightness modulation data DA are provided in the previous frame sub-period of the single frame period and no brightness modulation data DA is provided in the latter frame sub-period, the backlight driving circuit 13 then generates two sequential brightness modulation signals in the respective previous and latter frame sub-periods according to the two brightness modulation data DA.

In the illustrated embodiment, since the resolution of brightness modulation signal is 3-bit, and a range of on-cycle of brightness modulation signal in each frame sub-period is 0/7˜7/7 correspondingly. By combining the brightness modulation signals in the two sequential frame sub-periods, the range of on-cycle of brightness modulation signal in each frame period can be up to 0/14˜13/14, and thereby achieving 1 nit (i.e., 14 nits/14) backlight brightness resolution. Contradistinctively, if the method for modulating backlight brightness in the prior art is employed, only one brightness modulation data being provided in each single frame period to generate one brightness modulation signal, and thus the resultant backlight brightness resolution is 2 nits (i.e., 14 nits/7). In other words, the method for modulating backlight brightness associated with the illustrated embodiment can achieve a high backlight brightness resolution on the ground of a low resolution brightness modulation signal, and therefore the resolution of backlight brightness is increased.

It is noted that, the backlight brightness specification, the resolution of brightness modulation signal and the amount of frame sub-period in each single frame period only are exemplary and illustrative, which are not to limit the present invention. The skilled person in the art can choose suitable backlight brightness specification, resolution of brightness modulation signal and/or amount of frame sub-period in each single frame period according to actual application requirement.

In summary, the above-mentioned embodiments of the present invention change the provision amount of the brightness modulation data in a single frame period and perform a frequency multiplication operation applied to a brightness modulation signal generated according to the brightness modulation data, and therefore can achieve a high backlight brightness resolution through software programming at the prerequisite of no hardware change required by using the brightness modulation data with less bits (generally corresponding to low resolution of brightness modulation signal). Accordingly, the present invention can reduce the cost of display products in some degree and thus increase the competitive strength of the display products.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for increasing backlight brightness resolution, adapted for a non-emissive display device which uses a multi-bit brightness modulation data to modulate a backlight brightness thereof, the method comprising:
increasing a provision amount of the multi-bit brightness modulation data in a single frame period of the non-emissive display device; and
multiplying a frequency of a brightness modulation signal generated according to the multi-bit brightness modulation data, wherein a multiple of the frequency multiplying is associated with the provision amount of the multi-bit brightness modulation data in the single frame period.

2. The method as claimed in claim 1, wherein the multiple of the frequency multiplying is equal to the provision amount of the multi-bit brightness modulation data in the single frame period.

3. A method for modulating backlight brightness, adapted for a non-emissive display device which uses a multi-bit brightness modulation data to modulate a backlight brightness thereof, the method comprising:
sequentially providing M number of the multi-bit brightness modulation data in a single frame period of the non-emissive display device, wherein M is a positive integer and larger than 1; and
using the M number of multi-bit brightness modulation data to modulate the backlight brightness of the non-emissive display device in the single frame period.

4. The method as claimed in claim 3, wherein the step of using the M number of multi-bit brightness modulation data to modulate the backlight brightness of the non-emissive display device in the single frame period comprises:
demarcating the single frame period into M number of continuous frame sub-periods; and
taking the M number of multi-bit brightness modulation data respectively as brightness modulation data of the M number of continuous frame sub-periods.

5. A method for modulating backlight brightness, adapted for a non-emissive display device which uses a multi-bit brightness modulation data to modulate a backlight brightness thereof, the method comprising:
demarcating a single frame period of the non-emissive display device into a plurality of frame sub-periods; and
providing one the multi-bit brightness modulation data in each of the frame sub-periods of the single frame period to generate a brightness modulation signal, and thereby the backlight brightness of the non-emissive display device in the single frame period is modulated.
